(19) United States
(12) Patent Application Publication
(10) Pub. No.: US 2009/0216722 A1
(43) Pub. Date: Aug. 27, 2009

(54) Method and apparatus for querying digital records

(75) Inventor: Jong-ho Lea, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Gyeonggi-do (KR)

(21) Appl. No.: 12/289,614

(22) Filed: Oct. 30, 2008

(30) Foreign Application Priority Data
Feb. 22, 2008 (KR) 10-2008-0016498

(51) Int. Cl. G06F 17/30

(52) U.S. Cl. 707/3; 707/E17.014

(57) ABSTRACT

Provided is a method of querying digital records based on a map. The digital records querying method includes receiving a user input for selecting a query range from the map, interpreting the user input, and selecting the query range and a query processing method according to the result of the interpretation, and processing digital records included in the query range using the query processing method. Various query processing methods may be supported for application to a digital record, through a simple user input.

### CROSS-REFERENCE TO RELATED APPLICATIONS

This application claims priority from Korean Patent Application No. 10-2008-0016498, filed on Feb. 22, 2008, the disclosure of which is incorporated herein in its entirety by reference.

### BACKGROUND

1. Field

One or more embodiments of the present invention relate to digital records, and more particularly, to a method and apparatus for querying digital records based on a map.

2. Description of the Related Art

Texts, images, moving pictures, and various digital records including personal records, such as telephone numbers and schedules, can be created on the spot using a digital apparatus, such as a mobile phone including a digital camera, Personal Digital Assistant (PDA), Ultra-Mobile PC (UMPC), etc. A user's track can also be managed as a digital record using a navigation system. Digital records regarding a user's daily life are stored or managed based on time.

Recently, with the popularization of digital apparatuses in which a Global Positioning System (GPS) is installed, studies on a method of storing digital records related to daily lives based on time and location and displaying the stored information on a map are actively underway.

### SUMMARY

One or more embodiments of the present invention provide a method and apparatus for querying digital records on a map in order to allow a user to conveniently query the digital records and efficiently display the result of the query.

According to one or more embodiments, there is provided a method of querying digital records based on a map, including receiving a user input for selecting a query range from the map, interpreting the user input, and selecting the query range and a query processing method according to the result of the interpretation, and processing digital records included in the query range using the query processing method.

The method further includes displaying the processed digital records using a query result display method corresponding to the query processing method. The digital records are stored based on time and location.

The query processing method includes at least one of a first query processing method dividing and processing the digital records at regular time intervals, a second query processing method clustering and processing digital records satisfying a predetermined criterion in a time domain, and a third query processing method clustering and processing digital records satisfying a predetermined criterion in a space domain. The second query processing method clusters the digital records according to differences or similarity between the digital records. The third query processing method clusters the digital records according to a frequency or periodicity of recording. The query processing method uses a data aggregation function for reconfiguring associated digital records based on time and location.

The user input is at least two points, a straight line, a broken line, or a closed curve.

According to one or more embodiments, there is provided an apparatus of querying digital records based on a map, including an input unit receiving a user input for selecting a query range, an interpretation unit interpreting the user input, and selecting the query range and a query processing method according to the result of the interpretation, a processor processing digital records included in the query range using the query processing method, and a display unit displaying the processed digital records using a query result display method corresponding to the query processing method.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an apparatus of querying digital records, according to an exemplary embodiment;

FIG. 2 is a flowchart of a method of querying digital records, according to an exemplary embodiment;

FIG. 3 is a flowchart of a method of querying digital records, according to another exemplary embodiment;

FIG. 4 is a view for explaining digital records according to an exemplary embodiment;

FIGS. 5A through 5E are views for explaining user inputs according to various exemplary embodiments; and

FIG. 6A through 6C are views for explaining query processing methods and display methods according to various exemplary embodiments, respectively corresponding to the user inputs illustrated in FIGS. 5A through 5C.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

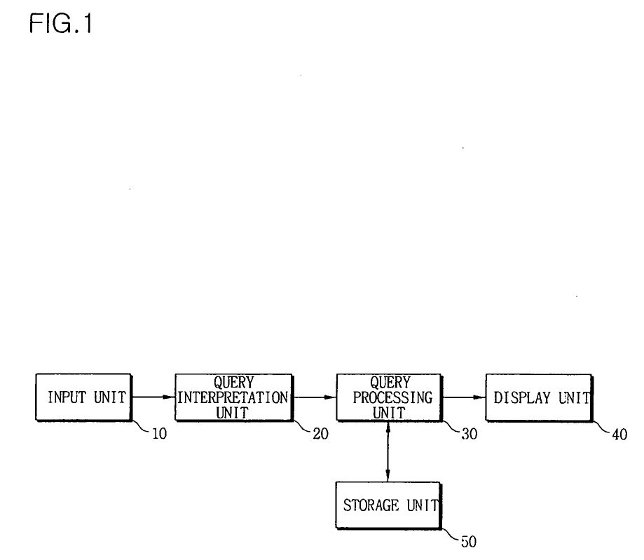

FIG. 1 is a block diagram of an apparatus of querying digital records, according to an exemplary embodiment.

Referring to FIG. 1, the digital record querying apparatus includes an input unit 10, a query interpretation unit 20, a query processor 30 and a display unit 40, and can further include a storage unit 50.

The digital record querying apparatus can be installed in various digital apparatuses which include a large-size display such as an Internet Protocol Television (IPTV), a mobile device, such as a mobile phone, Personal Digital Assistant (PDA), Ultra-Mobile PC (UMPC), navigation device, etc.

The input unit 10 receives a user input for selecting a query range. The input unit 10 can receive a predetermined user input to define a query range on a screen which displays a map, etc. For example, a user can designate his or her interesting region near “Gangnam” subway station on a map on which the area “Gangnam-gu” is displayed.

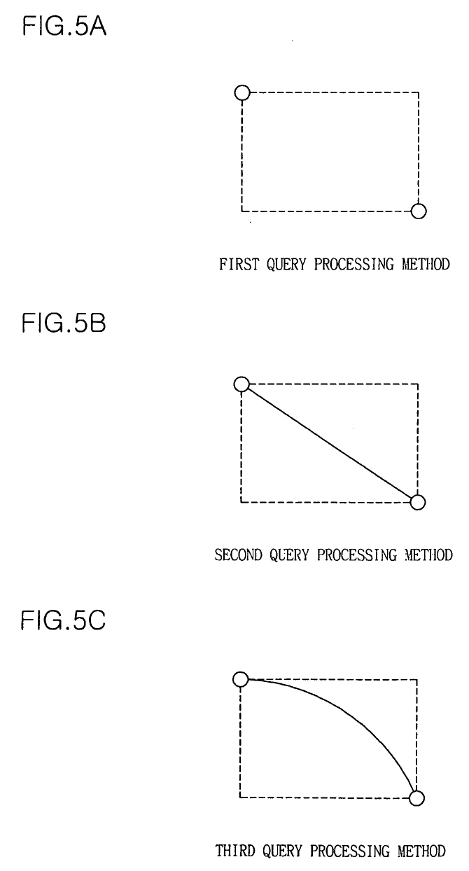

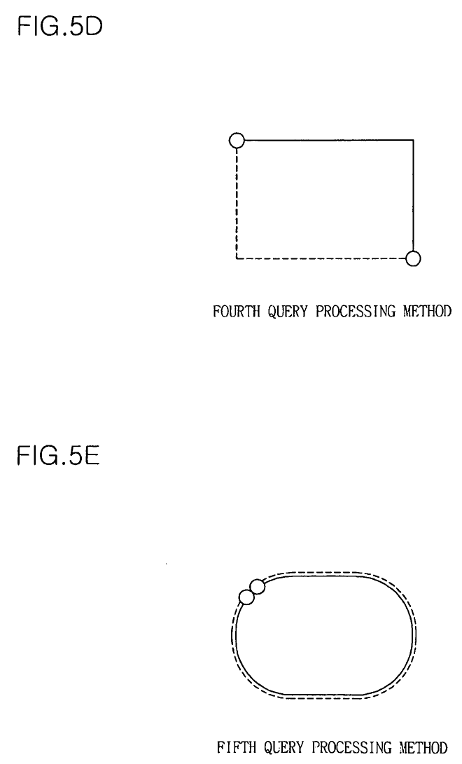

As illustrated in FIGS. 5A through 5E, the predetermined user input for defining a query range may be at least two points, a straight line, a curved line, a broken line or a closed curve, etc. Here, the query range may be defined as digital records having location information within a quadrangle area including the two points, straight line, curved line, broken line, or closed curve, etc. That is, as illustrated in FIGS. 5A through 5E, a quadrangle area defined by dotted lines can be selected as a query range. Accordingly, a user can select a query range easily on a displayed map, without inputting a word, etc. Here, the input unit 10 may be a touch screen, a pointing device, a remote controller for IPTV, etc.

The query interpretation unit 20 interprets the user input received through the input unit 10, and selects a query range and a query processing method according to the result of the interpretation. That is, if the user inputs at least two points, a straight line, a curved line, a broken line or a closed curve, the query interpretation unit 20 selects a quadrangle area including the user input as a query range, and also selects a predetermined query processing method corresponding to the user input. That is, the user input is used as selection information for selecting a query range and a query processing method.

For example, as illustrated in FIG. 5A, when the user inputs two points through the input unit 10, a quadrangle area (denoted by dotted lines) including the two points is selected as a query range, and a first query processing method corresponding to the two points is selected as a query processing method.

Also, as illustrated in FIG. 5B, when a straight line is input through the input unit 10, a quadrangle area (denoted by dotted lines) whose diagonal line corresponds to the straight line is selected as a query range, and a second query processing method corresponding to the straight line is selected as a query processing method.

Also, as illustrated in FIG. 5C, when a curved line is input through the input unit 10, a quadrangle area (denoted by dotted lines) including the curved line is selected as a query range, and a third query processing method corresponding to the curved line is selected as a query processing method.

Also, the user can input a broken line or an ellipse through the input unit 10, which are illustrated in FIGS. 5D and 5E. However, the above-mentioned types of user inputs are exemplary, and various other types can be added in correspondence to query processing methods.

The query processor 30 processes digital records included in the query range selected by the user input, using the selected query processing method. A query processing method can be defined using a data aggregation function corresponding to a user input described above. Here, the data aggregation function may be a predetermined function for reconfiguring associated digital records based on time and location.

The query processing method may include a first query processing method (also, referred to as a temporal indication mode) of dividing and processing digital records at regular time intervals, a second query processing method (also, referred to as a temporal aggregation mode) of clustering and processing digital records satisfying a predetermined criterion in a time domain, and a third query processing method (also, referred to as a spatial aggregation mode) of clustering and processing digital records satisfying a predetermined criterion in a space domain.

Here, the second query processing method can cluster the digital records according to the differences and/or similarities between the digital records, and the third query processing method can cluster the digital records according to the frequency or period of recording.

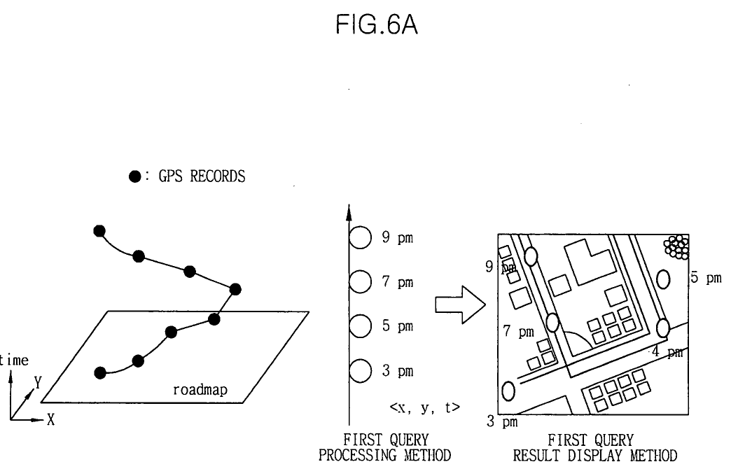

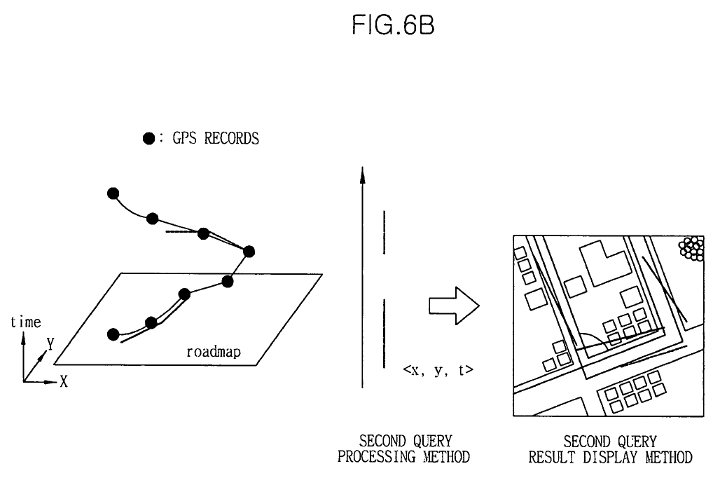

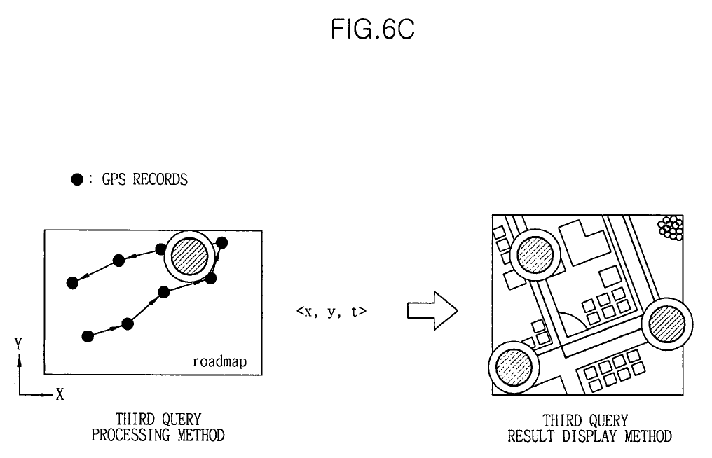

The display unit 40 displays the digital records processed by the query processor 30 using a query result display method corresponding to the selected query processing method. For example, the display unit 40 displays the processed digital records as a group of points, a group of lines, or a group of ellipses, which is suitable for the selected query processing method. Examples of query processing methods and query result display methods corresponding to the query processing methods are shown in FIGS. 6A through 6C.

According to an exemplary embodiment, FIG. 6A is a view for explaining a query processing method (a first query processing method, that is, a time indication mode) and a query result display method when two points are input to select a query range through the input unit 10 as illustrated in FIG. 5A. The exemplary embodiment illustrated in FIG. 6A corresponds to the case of querying digital records included in a query range corresponding to a quadrangle including two points at a predetermined time.

Digital records include information about GPS coordinates and recording times. When a query range is selected, digital records included in the query range based on the GPS coordinates are defined to a query target. For example, digital records at 3 PM, 5 PM, 7 PM, 9 PM, etc. are extracted from the digital records included in the query target, and the extracted digital records are displayed on a map. In FIG. 6A, digital records at predetermined times are displayed as groups of points on a map.

According to another exemplary embodiment, various time units can be used depending on the amount of digital record data included in a query range or depending on the types of user inputs, or a time unit designated as default can be used. According to another exemplary embodiment, digital records which are not within a predetermined radius Δr or within a predetermined time period Δt, that is, digital records at a changed location or at a changed time can be displayed as a group of points on a map.

According to another exemplary embodiment, FIG. 6B is a view for explaining a query processing method (a second query processing method, that is, a temporal aggregation mode) and a query result display method when a straight line for selecting a query range is input through the input unit 10 as illustrated in FIG. 5B. The exemplary embodiment illustrated in FIG. 6B corresponds to the case of clustering and processing digital records satisfying a predetermined criterion in a time domain among digital records included in a query range corresponding to a quadrangle including a straight line.

Here, the second query processing method can cluster the digital records according to differences and similarity between the digital records.

For example, digital records included in a query range selected by a user can be clustered according to differences in speed or distance between the digital records. The clustered digital records can be displayed as groups of lines on a map. The respective lines on the map can be displayed with different colors or with different line thicknesses to distinguish the respective lines from each other. For example, by respectively clustering data in a fast speed interval or data in a slow speed interval among navigation data, each clustered data can be displayed as a group of lines.

According to another exemplary embodiment, FIG. 6C is a view for explaining a query processing method (a third query processing method, that is, a spatial aggregation mode) and a query result display when a curved line is input to select a query range through the input unit 10 as illustrated in FIG. 5C. First, the exemplary embodiment illustrated in FIG. 6C corresponds to the case of clustering and processing digital records satisfying a predetermined criterion in a time domain among digital records included in a query range corresponding to a quadrangle including a curved line.

The third query processing method can cluster digital records according to the frequency or period of recording.

For example, a space area having repeatability or periodicity for each 24 hours, for each week, or for each month can be displayed as a group of ellipses. Or, a region (for example, a main living space) where the predetermined radius Δr or the predetermined time period Δt occurs more frequently than in the other regions can be displayed as a group of ellipses.

However, the above-described embodiments are exemplary, and various other embodiments can be implemented by changing the data aggregation function or the query result display method.

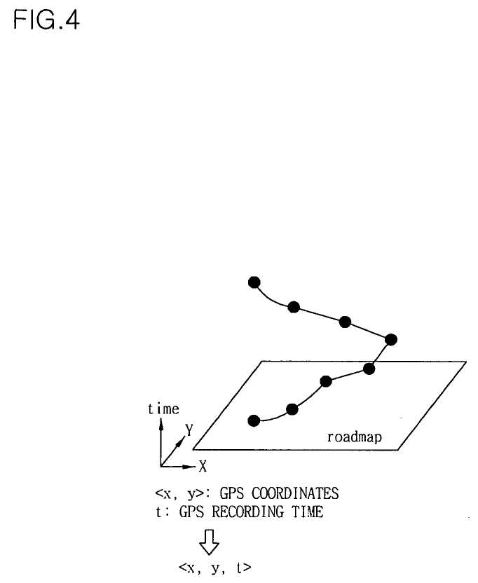

Again returning to FIG. 1, the storage unit 50 stores the digital records. The digital records can include various digital contents, such as images, moving pictures, words, telephone numbers, schedules, or a user's tracks obtained by a navigation system. The digital records can be stored based on GPS-based time and location information. An exemplary embodiment of digital records is shown in FIG. 4. In FIG. 4, GPS coordinates <x, y> and vector information <x, y, t> of the GPS coordinates <x, y> with respect to a GPS-based recording time t are stored in the storage unit 50 with the corresponding digital contents. By using the GPS-based information, associated digital records can be reconfigured and provided based on time and location.

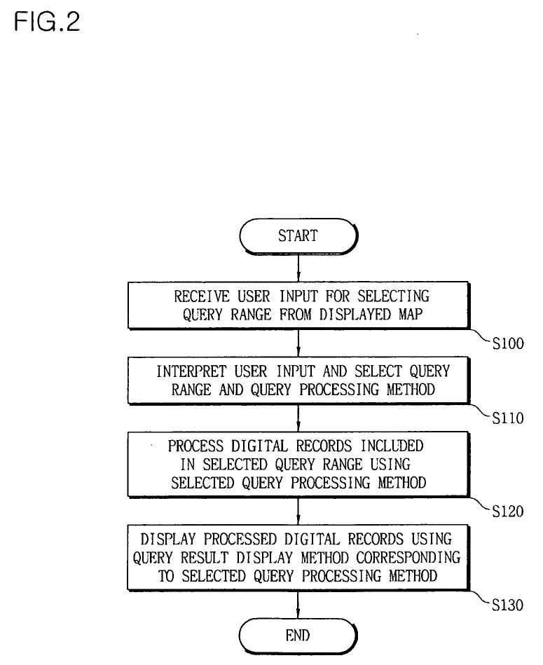

Meanwhile, FIG. 2 is a flowchart of a method of querying digital records, according to an exemplary embodiment.

Referring to FIGS. 1 and 2, the input unit 10 receives a user input to select a query range from a map displayed on a screen (operation S100). The user input may be one of exemplary embodiments described above with reference to FIGS. 5A through 5E, or a modification thereof.

The query interpretation unit 20 interprets the user input, and selects a query range and a query processing method (operation S100). That is, a user can select a query range and a query processing method at once through such a user input. Accordingly, a simple user interface for querying digital records can be provided.

The query processor 30 processes digital records included in the query range using the query processing method (operation S120). The query processing method can be defined using a data aggregation function corresponding to the user input. Here, the data aggregation function is used to reconfigure associated digital records based on time and location.

The display unit 40 displays the processed digital records on the screen, using a query result display method corresponding to the selected query processing method (operation S130).

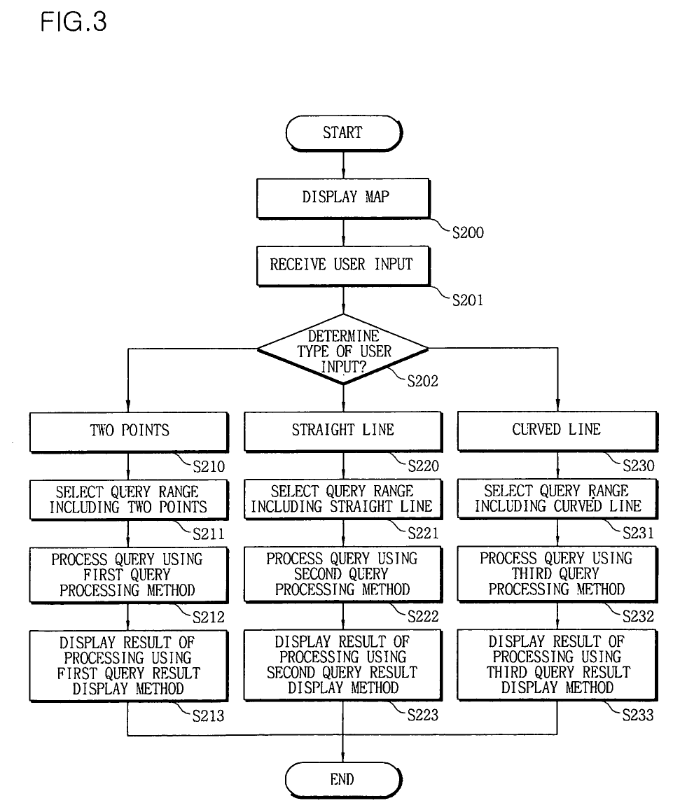

FIG. 3 is a flowchart of a method of querying digital records, according to another exemplary embodiment.

Referring to FIGS. 1 and 3, a map is displayed on the display unit 40 of the digital records querying apparatus illustrated in FIG. 1 (operation S200), and a user input is received through the input unit 20 (operation S201). The query interpretation unit 20 determines the type of the user input (operation S202). If the query interpretation unit 20 determines that the user input is two points (operation S210), the query interpretation unit 20 selects, as a query range, digital records having coordinates included in a quadrangle area including the two points on the map (operation S211). Then, the query processor 30 processes the selected digital records according to a predetermined query processing method (for example, a first query processing method) corresponding to the type of the user input (operation S212), and displays the result of the processing using a predetermined query result display method (for example, a first query result display method) corresponding to the query processing method (operation S213).

If the query interpretation unit 20 determines that the user input is a straight line (operation S220), the query interpretation unit 20 selects, as a query range, digital records having coordinates included in a quadrangle area including the straight line on the map (operation S221). Then, the query processor 30 processes the selected digital records according to a predetermined query processing method (for example, a second query processing method) corresponding to the type of the user input (operation S222), and displays the result of the processing using a predetermined query result display method (for example, a second query result display method) corresponding to the query processing method (operation S223).

If the query interpretation unit 20 determines that the user input is a curved line (operation S230), the query interpretation unit 20 selects, as a query range, digital records having coordinates included in a quadrangle area including the curved line on the map (operation S231). Then, the query processor 30 processes the selected digital records according to a predetermined query processing method (for example, a third query processing method) corresponding to the type of the user input (operation S232), and displays the result of the processing using a predetermined query result display method (for example, a third query result display method) corresponding to the query processing method (operation S233).

As described above, according to an exemplary embodiment, a method and apparatus for querying digital records on a map, which are used in a terminal having a GPS receiver or in a terminal including a camera, can store digital contents or track information based on time and location, interpret a user input for designating a quadrangle area for a query range to select a query processing method, perform query processing according to the query processing method, and display the result of the processing according to a proper query result display method.

Therefore, a query range, a query processing method, and a query result display method can be selected through a simple user input. The query result is used as an index for arranging, searching for, editing, and sharing records of life in a navigation device or a mobile terminal, etc. By using various data aggregation functions to effectively group times and locations at which digital records are made or to recognize the tendency of the digital records, it is possible to obtain a summary of the digital records, or to edit or share the digital records at meaningful intervals, as well as browsing the digital records.

Also, it is possible to support various query processing methods that are applied to a digital record, through a simple user input.

Although embodiments have been shown and described, it would be appreciated by those skilled in the art that changes may be made in these embodiments without departing from the principles and spirit of the invention, the scope of which is defined in the claims and their equivalents.

What is claimed is:

1. A method of querying digital records based on a map, comprising:
receiving a user input for selecting a query range from the map;
interpreting the user input, and selecting the query range and a query processing method according to a result of the interpretation; and
processing digital records included in the query range using the query processing method.

2. The method of claim 1, further comprising displaying the processed digital records using a query result display method corresponding to the query processing method.

3. The method of claim 1, wherein the digital records are stored based on time and location.

4. The method of claim 1, wherein the query processing method comprises at least one of:
a first query processing method dividing and processing the digital records at regular time intervals;
a second query processing method clustering and processing digital records satisfying a predetermined criterion in a time domain; and
a third query processing method clustering and processing digital records satisfying a predetermined criterion in a space domain.

5. The method of claim 4, wherein the second query processing method clusters the digital records according to differences and/or similarities between the digital records.

6. The method of claim 4, wherein the third query processing method clusters the digital records according to a frequency or periodicity of respective recording.

7. The method of claim 1, wherein the query processing method uses a data aggregation function for reconfiguring associated digital records based on time and location.

8. The method of claim 1, wherein at least two points, a straight line, a broken line, or a closed curve are recognizable as the user input.

9. An apparatus of querying digital records based on a map, comprising:
an input unit receiving a user input for selecting a query range;
an interpretation unit interpreting the user input, and selecting the query range and a query processing method according to a result of the interpretation;
a processor processing digital records included in the query range using the query processing method; and
a display unit displaying the processed digital records using a query result display method corresponding to the query processing method.

10. The apparatus of claim 9, further comprising a storage unit storing the digital records based on time and location.

11. The apparatus of claim 9, wherein the digital records are stored based on time and location.

12. The apparatus of claim 9, wherein the query processing method comprises at least one of:
a first query processing method dividing and processing the digital records at regular time intervals;
a second query processing method clustering and processing digital records satisfying a predetermined criterion in a time domain; and
a third query processing method clustering and processing digital records satisfying a predetermined criterion in a space domain.

13. The apparatus of claim 12, wherein the second query processing method clusters the digital records according to differences and/or similarities between the digital records.

14. The apparatus of claim 12, wherein the third query processing method clusters the digital records according to a frequency or periodicity of respective recording.

15. The apparatus of claim 9, wherein the query processing unit uses a data aggregation function for reconfiguring associated digital records based on time and location.

16. The apparatus of claim 9, wherein at least two points, a straight line, a broken line, or a closed curve are recognizable as the user input.
